(19) United States
(12) Patent Application Publication
(10) Pub. No.: US 2019/0210185 A1
(43) Pub. Date: Jul. 11, 2019

(54) DEVICE FOR COVERING A TOOTH PROFILE

(71) Applicant: Rolls-Royce Deutschland Ltd & Co KG, Blankenfelde-Mahlow (DE)

(72) Inventor: Gregor KAPPMEYER, Bad Homburg (DE)

(21) Appl. No.: 16/241,335

(22) Filed: Jan. 7, 2019

(30) Foreign Application Priority Data
Jan. 9, 2018 (DE) 10 2018 100 376.5

(51) Int. Cl. B24B 55/04; B24B 55/02; B23Q 11/10; B24B 19/00; B23F 23/12

(52) U.S. Cl. CPC B24B 55/045; B24B 55/02; B23F 23/12; B24B 19/009; B23Q 11/10

(57) ABSTRACT

A device for covering a tooth profile during machined processing with a tool, including an appliance for applying cooling lubricant to at least one contact area between the tool and the tooth profile during machine processing of the tooth profile by means of the tool. The appliance includes a guiding means by means of which a front face of the tooth profile in an area that is facing towards the contact area and an environment of the tooth profile in front of the area can be at least partially covered. The appliance is formed with at least one conduit which, in the operational state of the guiding means in which the tooth profile is covered, is arranged so as to extend in front of the tooth profile in the area that is shielded by the guiding means, and via which cooling lubricant can be supplied to the contact area through the guiding means.

This application claims priority to German Patent Application DE102018100376.5 filed Jan. 9, 2018, the entirety of which is incorporated by reference herein.

The invention relates to a method for covering a tooth profile according to the kind as it is more closely described in the generic term of patent claim 1.

In machining processes, in particular in processing by means of grinding, of tooth profiles, the supply of cooling lubricant constitutes a quality-determining element. If it is not possible to ensure a sufficient cooling lubricant supply, undesirably high operating temperatures, chip adhesions at the tool, such as a grinding tool or a grinding disc, as well as unfavorable cutting conditions can occur in the contact area or in the grinding gap between a tool or grinding tool and the work piece that is processed by means of machining or grinding. This may lead to so-called grinding burn, which entails a change of the tooth surface and a loss of hardness in the area of the tooth flank. Thus, the targeted supply of cooling lubricant into the grinding gap is an important precondition for a reliable grinding process.

Extensive measures for the targeted supply of cooling lubricants during the manufacture of gear tooth geometries are known from practice. In most cases, the cooling lubricant is supplied via flexible and manually adjustable or firmly installed coolant conduits in a manner substantially in parallel to the tool or to a grinding disc and in parallel to the tooth gap. Further, appliances are known, for example NC-controlled cooling lubricant nozzles, which can be repositioned if the tool diameter or grinding disc diameter changes by dressing, or when the processing direction of the tool or the grinding direction of the grinding disc has changed.

Further, embodiments are known in which cooling lubricant is respectively supplied into the contact area between the grinding disc and the work piece to be processed through strongly porous grinding discs. For this purpose, the cooling lubricant is pressed into the grinding body by means of nozzles, and is effectively used in the grinding gap for the purpose of process cooling. Here, the nozzles closely abut the grinding discs.

In addition, also cooling lubricant nozzles of different shapes are used. Here, so-called shoe nozzles or also nozzles with a plurality of tubes arranged in parallel are used to achieve an effective supply of cooling lubricant into the grinding gap.

When a grinding disc is inserted into a tooth gap, a gap is initially created, through which the cooling lubricant can enter into the cutting area, which is mostly guided into the grinding gap in parallel to the tooth gap during grinding of straight or oblique spur gear toothings. Here, the grinding disc is moved in the direction of the tooth flank line, and thus creates the desired profile. However, as soon as the grinding tool, for example a form-grinding wheel or a threaded grinding wheel, has entered the tooth gap so far that it mostly closes the tooth gap at the front surface of the teeth, only a small portion of the cooling lubricant can reach the cutting area. The largest portion of the supplied cooling lubricant is thrown back by the front surface of the gear wheel or laterally deflected, and also hinders the following coolant jet from reaching the grinding gap. In the further course of the process, a channel is again created which is formed by the grinding disc itself and the already ground tooth flank, and which facilitates a sufficient cooling lubricant supply

DE 10 2008 019 074 B3 discloses a method for grinding gears with external and/or internal teeth, and a device for manufacturing gears with a grinding tool that is embodied as a grinding disc or a threaded grinding wheel for inserting tooth gaps into a disc-shaped or cylindrical work piece. To be able to insert the cooling lubricant into the grinding gap in an easy and effective manner, it is proposed to arrange a guiding means at an entry or front face of a gear from which the grinding disc or threaded grinding wheel is applied. The guiding means is provided for positive-feeding cooling lubricant in particular when the tool is positioned above the toothing. Through the guiding means, the cooling lubricant is prevented from flowing off or spattering off the work piece, and thus is made available to a sufficient extent in the contact area between the grinding tool and the work piece to be processed. The cooling lubricant is supplied via a supply device that is moved with the tool, which is why the device is complex in its construction, and the grinding process is further characterized by a high control and regulating effort.

The present invention is based on the objective of further developing the known solutions in an advantageous manner.

According to the invention, this objective is achieved through a device with the features of patent claim 1.

The method according to the invention for covering a tooth profile during machined processing by a tool comprises an appliance for applying cooling lubricant to at least one contact area between the tool and the tooth profile during grinding processing of the tooth profile by the tool. The appliance has a guiding means with which a front face of the tooth profile in an area facing the contact area and an environment of the tooth profile in front of the area can be at least partially covered.

According to the invention, the appliance is embodied in a constructionally simple manner with at least one conduit which is arranged in the area which is shielded by the guiding means so as to extend in front of the tooth profile and via which cooling lubricant can be supplied to the contact area through the guiding means.

Via the conduit of the appliance, the cooling lubricant can be guided in a constructionally simple and targeted manner and with a small control and regulating effort in the direction of the processing gap and thus of the contact area between the tool and the tooth profile.

In a further advantageous embodiment of the device according to the invention, the guiding means—in its operative state in which it covers the tooth profile—delimits at least one channel that is open towards the tool and that can be arranged so as to be at least partially aligned with a tooth intermediate space of the tooth profile. In this way, it is again achieved in a simple manner that the cooling lubricant is guided to the desired extent in the direction of the contact area between the tool and the tooth profile during the machined processing of the tooth profile. This is also the case if the cooling lubricant is supplied in the direction of the contact area not only through the conduit of the appliance but also via a further supply device.

If, in the operative state of the guiding means in which it covers the tooth profile, the at least one conduit opens into the channel in an area of the channel that faces towards the front face of the tooth profile, a targeted cooling lubricant supply into the processing gap is again facilitated with small effort.

In a further advantageous embodiment of the device according to the invention, the guiding means has a shape in the abutment area at the front surface of the tooth profile that is adjusted at least approximately to the shape of the tooth profile. In this way, it is again ensured that the cooling lubricant can be guided in the transitional area between the guiding means and the tooth profile in a substantially unobstructed manner in the direction of the processing gap or of the contact area between the tool and the tooth profile.

In a further advantageous exemplary embodiment of the device according to the invention, the lateral walls of the guiding means that delimit the channel have respectively a profile in which the channel width is increased with growing distance from the front surface of the tooth profile. In this way, on the one hand, the guiding means forms a streamlined supply device for cooling lubricant that is to be introduced into the processing gap and, on the other hand, prevents the cooling lubricant to be supplied from impinging onto the front surface of the tooth profile perpendicularly, whereby a streamlined introduction of the cooling lubricant into the processing gap is ensured.

If, in the abutment area at the front surface of the tooth profile, the lateral surfaces of the guiding means have a height that corresponds to the tooth height between a tooth base and a tooth tip of the tooth profile, substantially the entire front surface of the tooth profile is shielded in the area of a tooth to an extent that is advantageous for the supply of cooling lubricant. In addition, in this further development of the device according to the invention, the height of the lateral surfaces of the guiding means decreases at least in certain areas with increasing distance from the abutment area at the front surface of the tooth profile, whereby the guiding means delimits a handling area of the tool to an extend that becomes less with increasing distance from the tooth profile.

In a further advantageous embodiment of the device according to the invention, the orifice area of the conduit that opens into the channel is embodied in such a manner that the cooling lubricant discharged from the conduit in the operative state of the guiding means in which it covers the tooth profile can be guided in the direction of the contact area between the tool and the tooth profile without additional actuation effort.

Here, there is the possibility of embodying the orifice area to be circular, elliptical, slit-shaped or angular shaped manner.

If the appliance has two conduits and respectively one orifice area of a conduit is provided in the area of one of the lateral surfaces of the guiding means that delimit the channel that can be assigned to the tooth intermediate space, a contact area between the one side of the tool and a tooth flank of a first tooth of the tooth profile and at the same time the contact area between the other side of the tool and a tooth flank of a second tooth of the tooth profile can be impinged with cooling lubricant.

In a constructionally simple embodiment of the device according to the invention that is favorable with respect to the installation space, the conduits are connected to a common cooling lubricant supply area.

In a further advantageous embodiment of the device according to the invention, cooling lubricant is thus applied to the processing gap to the desired extent based on the fact that the direction with which the cooling lubricant can be guided from the conduit in the direction of the contact area between the tool and the tooth profile and a rotational direction of the tool in the contact area with the tooth profile correspond to each other.

If the appliance has multiple guiding means wherein respectively one guiding means can be respectively assigned to two teeth and a tooth intermediate space of the tooth profile delimited by them, the tooth profile can be processed with short set-up times.

In a further advantageous embodiment of the device according to the invention, the appliance has a structural component that is connected to the guiding means. The structural component can be brought in operative connection with a work piece holder. In addition, the cooling lubricant supply area is provided in the area of the structural component.

Here, there is the possibility of attaching the device at the tooth profile, or of it being a part of the holding device for affixing the tooth profile during grinding, or even it being a part of the machine tool that is used for processing of the tooth profile.

Further, there is also the possibility of the device being embodied in a single part or in multiple parts.

In a multi-part design of the device, the appliance has a structural component that is connected to the guiding means and that is connected in a movable manner to a further structural component which in turn can be brought into operative connection with the tool holder. Thus, the possibility of the device being received, displaced or supported in a tool holder or other structural elements of a machine tool is provided in a simple manner to facilitate automated switching of structural components.

In addition, there is also the possibility of embodying the device with attachment means for affixing as well as for aligning with the tooth profile or a holding device of the tooth profile. Here, one or multiple positive-locking elements can be provided that are embodied in accordance with one or multiple form elements of the tooth profile or of the device itself. Further, also attachment elements, such as magnets, screw connections or releasable adhesive connections or the like can be provided.

Moreover there is the possibility of designing the device in such a manner that it can be received, displaced and supported by a tool holder or other structural elements of the machine to facilitate automatized switching of structural components.

In a further advantageous embodiment of the device according to the invention, the cooling lubricant supply area comprises areas that conduct cooling lubricant in the structural component as well as in the further structural component. Further, an interface between the structural component and the further structural component is sealed off against an environment by means of a seal. In this way, the supply of cooling lubricant from the further structural component that is preferably connected to a static machine tool part into the structural component that is connected to the tooth profile and embodied so as to be movable with respect to the further structural component can be realized without cooling lubricant losses.

The seal may for example comprise sealing rings, or the like.

If the cooling lubricant supply area is formed in such a manner that cooling lubricant can respectively only be applied to the conduit from the cooling lubricant supply area, via the orifice area of which cooling lubricant can be applied to a contact area between the tooth profile and the tool, it is ensured with small effort that only the required cooling lubricant amount is supplied.

Depending on the respectively present application case, there is again the possibility of attaching the device at the tooth profile before the latter is processed, and removing it again after processing.

Further, the device can be aligned with the structural component following the either planned or already present division of the teeth.

In addition, the device can be made entirely or partially of materials such as for example of plastic materials, or of metals, or of combinations of multiple materials.

In addition, there is the possibility of manufacturing the device by means of molding, additive manufacturing methods, such as 3D printing or additive manufacturing processes, or by means of machining methods, such as for example milling, or the like.

Grinding burn caused by a reduced cooling lubricant supply in critical areas of tooth profiles can be prevented by simply arranging the device according to the invention at the front face of a toothing to be processed. A streamlined design of the device facilitates a targeted and effective introduction of cooling lubricant into the grinding gap with the effect of a considerable increase in the amount of cooling lubricant in the grinding gap as compared to devices in which the cooling lubricant is supplied via conventional cooling lubricant nozzles.

Here, there is the possibility of introducing the cooling lubricant in a targeted manner into the cooling lubricant channels adjoining the processing gap between the tool and the machined work piece to be processed by means of a two-piece device for transferring the cooling lubricant.

In general, the device according to the invention can be used in the processing of spur gears and helical gears in which tooth gaps are processed discontinuously or continuously, for example by means of grinding, such as pin grinding, profile grinding or the like, milling, such as hobbing or discontinuous profile milling, shaping or broaching. Here, it can be provided that the spur gear teeth are machine-processed for example with a threaded grinding wheel, with a grinding disc, with an end-milling cutter, with a disc milling cutter, or the like. This means that the device according to the invention can generally be used in the manufacture of gear wheels that are for example used in aircraft engines or also in other industrial fields, such as e.g. in the automobile industry.

What is proposed by means of the device according to the invention is a device-side or component-side modification of the gap geometry of a tooth profile to avoid the disadvantages as they are known from the state of the art and as they result from an insufficient cooling lubricant supply in partial areas of the tooth flank.

For this purpose, it can be provided that a streamlined shape of the auxiliary device is attached or positioned at the machine tool, at the device, or at the tooth profile itself, facilitating a targeted cooling lubricant supply into the grinding gap. Here, the geometric design of the device is such that for example a front surface of a gear wheel, but especially the front faces of the teeth themselves, are in mostly covered by the device. In this way, it is avoided in a simple manner that cooling lubricant can impinge mostly perpendicularly onto the front surface of the gear wheel to be ground, and thus a streamlined entry into the grinding gap is ensured.

Moreover, it is provided that the cooling lubricant is guided as required—either exclusively or in addition to external cooling lubricant supplies—through the conduits or cooling lubricant channels arranged inside the device in the direction of the processing gap, such as a grinding gap. Here, the cooling lubricant can be introduced into the processing gap close to the transition of the device into the gear wheel front face, and thus in a targeted manner.

Depending on the respectively present application case, the device further has an element that facilitates for the cooling lubricant to be guided in such a manner that cooling lubricant is supplied only through the cooling lubricant channels that are directly adjacent to the processing gap, so that the largest portion of the cooling lubricant reaches the actual processing gap. This is for example achieved through a chamber that is embodied in such a manner that it guides the cooling lubricant only inside respectively two cooling lubricant channels that adjoin the processing gap.

The features specified in the patent claims as well as the features specified in the following exemplary embodiment of the device according to the invention are suitable to further develop the subject matter according to the invention respectively on their own or in any desired combination with each other.

Further advantages and advantageous embodiments of the device according to the invention follow from the patent claims and from the exemplary embodiment that is described in principle in the following by referring to the drawing.

Herein:

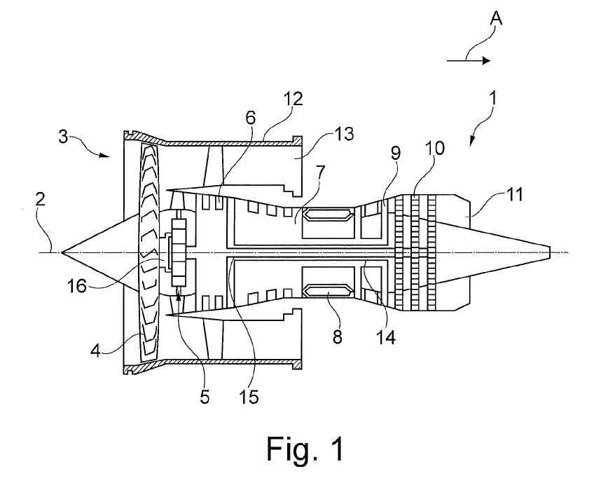

FIG. 1 shows a simplified sectional view of an aircraft engine with a fan and with a low-pressure turbine, wherein the fan is connected to a low-pressure turbine via a gear;

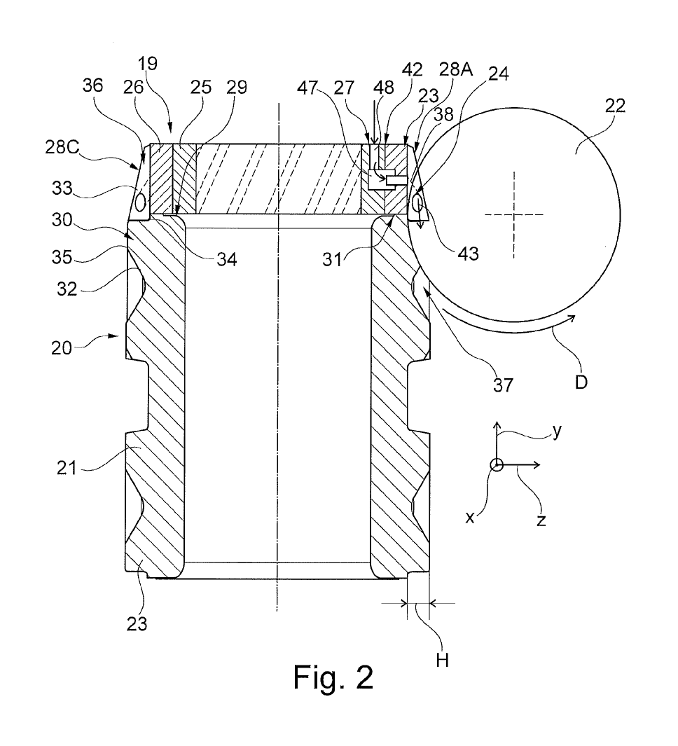

FIG. 2 shows a longitudinal section view of a gear wheel and a grinding tool, wherein a device for covering the tooth profile of the gear wheel during the grinding process of the tooth profile with the grinding tool is arranged at a front face of the gear wheel; and

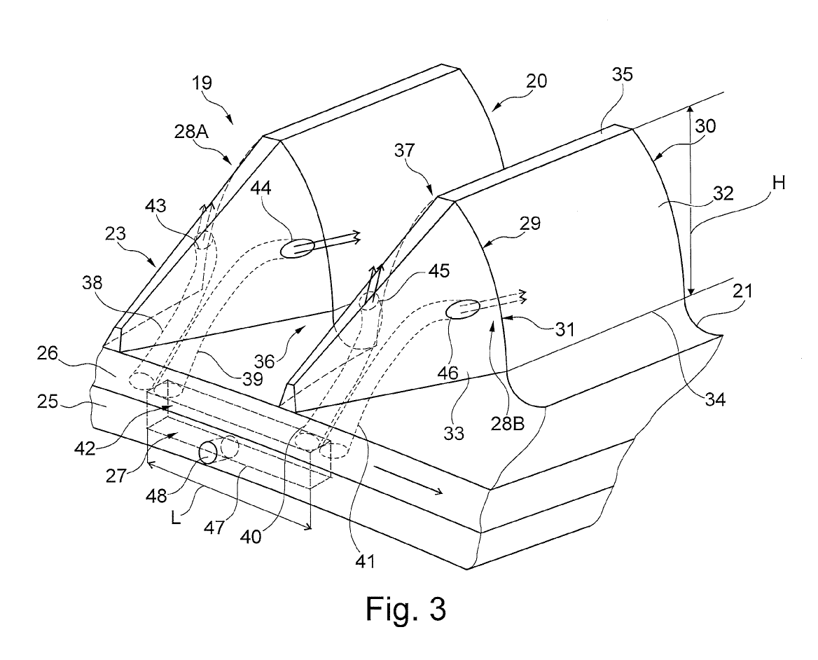

FIG. 3 shows an enlarged three-dimensional partial view of the device for covering according to FIG. 2.

FIG. 1 shows a turbomachine that is embodied as an aircraft engine 1 of an aircraft with a gear 5 that is embodied as a planetary gear. The aircraft engine 1 is a turbomachine with which the gear 5 can be advantageously combined. As will be clearly shown in the following, the gear 5 can also be used in differently embodied turbomachines, such as a propeller-type turbine air jet engine or a turboprop.

The aircraft engine 1 has a main rotational axis 2. Further, in the axial flow direction A, the aircraft engine 1 comprises an air intake 3, a fan 4, the gear 5, a low-pressure compressor 6, a high-pressure compressor 7, a combustion device 8, a high-pressure turbine 9, a low-pressure turbine 10 and an exhaust nozzle 11. An engine nacelle 12 surrounds the aircraft engine 1 and delimits the air intake 3.

The aircraft engine 1 operates in a conventional manner, wherein air entering the intake 3 is accelerated by the fan 4 to create two air flows. A first air flow flows into the intermediate-pressure compressor 6 and a second air flow is passed through a subsidiary flow channel 13 or bypass channel to provide a drive thrust. The intermediate-pressure compressor 6 compresses the air flow that is supplied to it, before the air is further compressed in the area of the high-pressure compressor 7.

The compressed air that is discharged from the high-pressure compressor 7 is introduced into the combustion appliance 8, where an intermixing with fuel occurs, and the fuel-air mixture is combusted. The resulting hot combustion products expand and in doing so drive the high-pressure turbine 9 and the low-pressure turbine 10 before they are discharged via the discharge nozzle 11 to provide additional drive thrust. The high-pressure turbine 9 and the low-pressure turbine 10 drive the high-pressure compressor 7 or the intermediate-pressure compressor 6 by means of a high-pressure shaft 14 or a low-pressure shaft 15. The low-pressure shaft 15 that couples the low-pressure turbine 10 with the intermediate-pressure compressor 6 is coupled to the fan 4 via gear 5 which represents a reduction gear. A drive torque that is applied via the low-pressure shaft 15 to the gear 5 is increased according to the stationary gear ratio of the gear 5 and is supplied to a fan shaft 16. If the fan 4 is driven by the low-pressure turbine 10, the rotational speed of the low-pressure shaft 15 is reduced according to the gear ratio of the gear 5 and the fan shaft 16 as well as the fan 4 are driven with this reduced rotational speed and with a torque that is increased as compared to the torque that is applied to the low-pressure shaft 15.

In the embodiment of the gear 5 shown in FIG. 1, a sun wheel of the gear 5 is connected in a torque-proof manner to the low-pressure shaft 15 and a planetary carrier of the gear 5 is connected in a torque-proof manner to the fan shaft 16. A hollow wheel of the gear 5 is fixedly attached at the housing. What is thus present is a so-called epicyclic embodiment of the gear 5. Independently of that, the gear 5 can also comprise other embodiments of a planetary gear.

In the following, an embodiment of a device 19 for covering a tooth profile 20 of a double helical spur gear or gear wheel 21, which is a planetary wheel of the gear 5, as it is shown in more detail in FIG. 2 and FIG. 3, is described in more detail based on a grinding process with a grinding tool 22 that is embodied as a grinding disc.

Independently of that, the device 19 can be used in other machined processing procedures, such as milling, punching, broaching, or the like to the extent as it is described below in order to introduce cooling lubricant into a processing gap between the tool that is respectively used for processing a gear wheel and the currently processed surface of the work piece, namely to such an extent that the known disadvantages due to inadmissibly high local structural component temperatures as they are caused by processing are avoided.

The device 19 is embodied with an appliance 23 for applying cooling lubricant to a contact area between the grinding tool 22 and the tooth profile 20 during the process of grinding the tooth profile 20 by means of the grinding tool 22.

Moreover, FIG. 3 shows an enlarged three-dimensional partial view of the gear wheel 21 and the device 19. As can be seen in a combined view of the renderings according to FIG. 2 and FIG. 3, the device 19 comprises a first hollow-cylindrical structural component 25 that is arranged radially inside a second structural component 26 that is also embodied to be hollow-cylindrical at least in certain areas. In the present case, the radially inner first structural component 25 is connected in a torque-proof manner (to an extent that is not shown here in any more detail) to a machine tool which is not shown in any more detail and which provides the drive for the grinding tool 22. The second structural component 26 is arranged and mounted on the first structural component 25 so as to be rotatable in the circumferential direction of the first structural component 25, and is also embodied with a cooling lubricant supply area 27 via which the cooling lubricant can be guided in the manner more closely described below through the first structural component 25 and through the second structural component 26 in the direction of the contact area 24.

The second structural component 26 comprises guiding means 28A to 28C, which in the present case are embodied in one piece with the first structural component 26 and which are distributed over the circumference of the device 19 in a manner corresponding to the tooth profile 20 of the gear wheel 21. The guiding means 28A to 28C abut a front face 29 of the tooth profile 20 or front faces 29 of the teeth 30 of the tooth profile 21, and thus cover the total tooth profile 20 of the gear wheel 21.

In the abutment area 31 at the front face 29 of the tooth profile 20, the guiding means 28A to 28C have an outer shape that corresponds to the tooth profile 20, so that a substantially stepless transition is present in the abutment area 31 between the outer sides 32 of the teeth 30 and the lateral walls or lateral surfaces 33 of the guiding means 28A to 28C. In the abutment area 13 at the front surface or the front face 29 of the tooth profile 20, a height of the lateral surfaces 33 of the guiding means 28A to 28C corresponds of a tooth height H between a tooth base 34 and a tooth tip 35. In addition, the height of the lateral surfaces 33 decreases with growing distance in the y-direction or in the axial direction of the gear wheel 21. The guiding means 28A to 28C delimit, to the extent shown in more detail in FIG. 2, a channel 36 that is open towards the grinding tool 22 and arranged so as to be aligned with a tooth intermediate space 37.

Two conduits 38, 39 or 40, 41 are respectively provided in the guiding means 28A to 28C in the manner shown in FIG. 3. In the present case, the conduits 38, 39 or 40, 41 extend from an interface 42 between the first structural component 25 and the second structural component 26 to the orifice areas 43 to 46 that are provided in the lateral surfaces 33 of the guiding means 28A 28C close to the abutment areas 31. Here, the conduits 39 and 40 open into the channel 36 that is arranged in congruence with the tooth intermediate space 37 between the two teeth 30 of the tooth profile 20 shown in FIG. 3.

In the abutment area, a width of the guiding means 28A to 28C corresponds 31 to the tooth base width and decreases to the shown extent with increasing distance from the abutment area 31 in the y-direction. Thus, the channel 36 has a profile that widens in y-direction starting at the abutment area 31, and that, during a supply of cooling lubricant to the gear wheel 21 from an additional machine tool-side supply device, can be guided into the tooth intermediate space 37 in a fluidically advantageous manner in addition to the supply via the conduits 39 and 40.

In the first structural component 25, the cooling lubricant supply area 27 is formed with a cooling lubricant chamber 47 to which cooling lubricant can be applied via a supply opening 48. Here, a length L of the cooling lubricant chamber 47 in the circumferential direction of the device 19 is dimensioned in such a manner that respectively two conduits 39 and 40 that are assigned to a tooth intermediate space 37 are in operative connection with the cooling lubricant supply area 27 which is currently being ground by means of the grinding tool 22, while cooling lubricant is not applied to the further conduits 38, 41 which are assigned to tooth intermediate spaces 37 that are currently not being ground. In continuous processing procedures, such as generation grinding with a threaded grinding wheel, the number of the supplied intermediate grinding spaces is increased corresponding to the number of the intermediate grinding spaces that are ground at the same time.

Among other things, the described constructional embodiments of the device 19 are based on the fact that in the course of the grinding process the grinding tool 22 is moved through the tooth intermediate space 37 only in the y-direction, and at the end of the grinding process is guided either in the y-direction or in the z-direction out of the meshing area with the tooth profile 20 and also out of the meshing area with the device 19. Subsequently, the gear wheel 21 is rotated together with the guiding means 28A to 28C and with the second structural component 26 in the circumferential direction or in the x-direction until the grinding tool 22 can be inserted into a further tooth intermediate space 19. Here, the first structural component 25 that is connected in a torque-proof manner to the machine tool remains in the position that is shown in FIG. 3, so that the conduits 39 and 40 are no longer connected to the cooling lubricant chamber 47. By twisting the gear wheel 21 and the second structural component 26, the further conduits that are assigned to the tooth intermediate space 37 that is now to be further processed by grinding enter into operative connection with the cooling lubricant chamber 47, and cooling lubricant can be introduced to the desired extent into the tooth intermediate space 37 to be processed.

Depending on the respectively present application case, there is also the possibility that, instead of the tooth profile of a gear wheel, a tooth profile of a gear rack or of a gear wheel segment is processed by grinding, wherein in that case the device 19 is not embodied in a hollow-cylindrical but likewise in a bar-like or merely segment-like manner.

If only one tooth flank of a tooth is processed in the course of the grinding procedure of a tooth profile, there is also the possibility of embodying the device with only one guiding means. Further there is also the possibility of designing the device with only two guiding means 28A and 28B, and of respectively twisting the gear wheel 21 with respect to the device 19 until the next teeth to be ground are congruent with the guiding means 28A and 28B.

The direction in which the cooling lubricant can be guided from the conduits 38 to 41 in the direction of the contact area 24 between the grinding tool 4 and the tooth profile 2 and a rotational direction D of the grinding tool 22 correspond to each other in the contact area 24. Thus, the cooling lubricant that is supplied in the tooth intermediate space 37 is conveyed by the grinding tool 22 to the desired extent into the contact area 24, and grinding burn is avoided to the desired extent.

### PARTS LIST

1 turbomachine; aircraft engine
2 main rotational axis
3 air intake
4 fan
5 gear
6 low-pressure compressor
7 high-pressure compressor
8 combustion device
9 high-pressure turbine
10 low-pressure turbine
11 exhaust nozzle
12 engine nacelle
13 bypass channel
14 high-pressure shaft
15 low-pressure shaft
16 fan shaft
19 device
20 tooth profile
21 spur gear
22 grinding tool
23 appliance
24 contact area
25 first structural component
26 second structural component
27 cooling lubricant supply area
28A to 28C guiding means
29 front face
30 teeth
31 abutment area
32 outer side
33 lateral surface
34 tooth base
35 tooth tip
36 channel
37 tooth intermediate space
38 to 41 conduit
42 interface between the structural components
43 to 46 orifice area
47 cooling lubricant chamber
48 supply opening
D rotational direction of the grinding tool
H tooth height
L length of the cooling lubricant chamber

1. A device for covering a tooth profile during machine-processing with a tool, comprising an appliance for applying cooling lubricant to at least one contact area between the tool and the tooth profile during machined processing of the tooth profile by means of the tool, wherein the appliance has a guiding means with which a front face of the tooth profile in an area that is facing towards the contact area and an environment of the tooth profile in front of the area can be covered at least partially, wherein the appliance is embodied with at least one conduit, which—in the operative state of the guiding means in which it covers the tooth profile—is arranged in the area that is shielded by the guiding means so as to extend in front of the tooth profile, and via which cooling lubricant can be supplied to the contact area through the guiding means.

2. The device according to claim 1, wherein, in its operative state in which it covers the tooth profile, the guiding means delimits at least one channel that is open towards the tool and that can be arranged so as to be at least partially aligned with a tooth intermediate space of the tooth profile.

3. The device according to claim 2, wherein, in the operative state of the guiding means in which it covers the tooth profile, the at least one conduit opens into the channel in an area of the channel that is facing towards the front face of the tooth profile.

4. The device according to claim 1, wherein, in an abutment area at the front face of the tooth profile, the guiding means has a shape that is at least approximately adjusted to the shape of the tooth profile.

5. The device according to claim 2, wherein the lateral walls of the guiding means that delimit the channel respectively have a profile in which the channel width is increased with growing distance from the front face of the tooth profile.

6. The device according to claim 5, wherein, in the abutment area at the front face of the tooth profile, the lateral walls of the guiding means have a height that corresponds to the tooth height between a tooth base and a tooth tip of the tooth profile, wherein the height of the lateral walls of the guiding means respectively decreases with increasing distance from the abutment area at the front face of the tooth profile at least in certain areas.

7. The device according to claim 2, wherein the orifice area of the conduit opening into the channel is embodied in such a manner that, in the operative state of the guiding means in which it covers the tooth profile, the cooling lubricant discharged from the conduit can be guided in the direction of the contact area between the tool and the tooth profile.

8. The device according to claim 2, wherein the appliance has at least two conduits, wherein respectively one orifice area of a conduit is provided in the area of one of the lateral surfaces of the guiding means that delimit the channel that can be assigned to the tooth intermediate space.

9. The device according to claim 8, wherein the conduits are connected to a common cooling lubricant supply area.

10. The device according to claim 1, wherein the direction in which the cooling lubricant can be guided from the conduit in the direction of the contact area between the tool and the tooth profile and a rotational direction of the tool in the contact area with the tooth profile correspond to each other.

11. The device according to claim 2, wherein the appliance has multiple guiding means, wherein respectively one guiding means can be assigned to respectively two teeth and a tooth intermediate space of the tooth profile that is delimited by them.

12. The device according to claim 9, wherein the appliance has a structural component that is connected to the guiding means and that can be brought into operative connection with a work piece holder, with the cooling lubricant supply area being provided in its area.

13. The device according to claim 1, wherein the appliance has a structural component that is connected to the guiding means and that is connected in a movable manner to the further structural component, which in turn can be brought in operative connection with a tool holder.

14. The device according to claim 13, wherein the cooling lubricant supply area comprises cooling lubricant conducting areas in the structural component as well as in the further structural component, wherein an interface between the structural component and the further structural component is sealed off against an environment by means of a seal.

15. The device according to claim 9, wherein the cooling lubricant supply area is embodied in such a manner that cooling lubricant from the cooling lubricant supply area can respectively only be supplied to that conduit that has an orifice area via which cooling lubricant can be applied to a contact area between the tooth profile and the tool.
